(19) United States
(12) Patent Application Publication
(10) Pub. No.: US 2017/0312925 A1
(43) Pub. Date: Nov. 2, 2017

(54) FOLDING KNIFE WITH ASSISTED OPENING FUNCTION

(71) Applicant: Chih-Chen KAO, Taoyuan City (TW)

(72) Inventor: Chih-Chen KAO, Taoyuan City (TW)

(21) Appl. No.: 15/172,244

(22) Filed: Jun. 3, 2016

(30) Foreign Application Priority Data
Apr. 27, 2016 (TW) 105205995

(51) Int. Cl. B26B 1/04

(52) U.S. Cl. CPC B26B 1/04

(57) ABSTRACT

The present invention is to provide a folding knife with an assisted opening function, which comprises a handle; a blade pivotally connected to a first end of the handle through a pivot shaft and having a notch formed at a position adjacent to the pivot shaft and a cutting edge thereof; and a pushing member having a pushing portion exposed outside the handle, an end pivotally connected in the handle between the pivot shaft and a second end of the handle, and a pressing post formed at a middle section thereof and configured to be engaged in the notch when the cutting edge is received in the handle and to push a wall of the notch that is relatively far from the pivot shaft and thereby rotate the blade away from the handle through a predetermined angle when the pushing portion is pushed toward the second end of the handle.

### FIELD OF THE INVENTION

The present invention relates to a folding knife, more particularly to a folding knife with an assisted opening function comprising a handle; a blade pivotally connected to a first end of the handle through a pivot shaft and having a notch formed at a position adjacent to the pivot shaft and a cutting edge thereof; and a pushing member having a pushing portion exposed outside the handle, an end pivotally connected in the handle between the pivot shaft and a second end of the handle, and a pressing post formed at a middle section thereof and configured to be engaged in the notch when the cutting edge is received in the handle and to push a wall of the notch that is relatively far from the pivot shaft and thereby rotate the blade away from the handle through a predetermined angle when the pushing portion is pushed toward the second end of the handle.

### BACKGROUND OF THE INVENTION

Folding knives are very common tools nowadays. The main structure of a folding knife includes a blade pivotally connected to a handle so that, when a user has finished using the folding knife, the blade can be pivoted into the handle and stored therein to save space, facilitate carrying, and ensure that the sharp cutting edge will not cut the user or damage nearby objects. In order to pivot rapidly and smoothly from inside the handle when the folding knife is to be used, the blade is typically provided with a post configured to be pushed by the user (hereinafter referred to as the pushing post), and the handle is provided therein with a spring. The user only has to rotate the blade through a small angle by pushing the pushing post, and the elastic restoring force of the spring will drive the blade out of the handle.

FIG. 1A and FIG. 1B show the structure of a conventional folding knife 1, which includes a blade 11 and a handle 13. The blade 11 is pivotally connected to the handle 13 in order to be rotated out of and back into the handle 13. In addition, the blade 11 is protrudingly provided with a pushing post 111, which remains exposed outside the handle 13 while the blade 11 is received in the handle 13. Also, an elastic plate 15 is provided in the handle 13 and has a free end extending to a position adjacent to the pivot joint of the blade 11. As shown in FIG. 1A, when the blade 11 is completely received in the handle 13, the elastic plate 15 is pressed against one end of the blade 11, and the portion of the elastic plate 15 that is pressed against the blade 11 applies a first force L1 to the blade 11 (as indicated by the dashed-line arrow in FIG. 1A). The first force L1 tends to rotate the blade 11 inward of the handle 13 such that the blade 11 is securely positioned in the handle 13.

Conversely, referring to FIG. 1B, once the user pushes the pushing post 111 and thereby rotates the blade 11 out of the handle 13 through a predetermined angle (about 4-8 degrees), the elastic plate 15 applies a second force L2 to the blade 11 (as indicated by the dashed-line arrow in FIG. 1B). The second force L2 tends to rotate the blade 11 outward of the handle 13 such that the blade 11 spins completely out of the handle 13 in an instant.

FIG. 2 shows the structure of another conventional folding knife. (For the convenience of description, components in FIG. 2 that have identical counterparts in FIG. 1A and FIG. 1B use the same reference numerals as their respective counterparts.) The folding knife in FIG. 2 is so designed that the blade 11 is driven not by the elastic plate 15 but by a torsion spring 21. The torsion spring 21 is provided around the pivot shaft of the handle 13 and keeps applying a force to the blade 11 that tends to rotate the blade 11 outward of the handle 13. While the blade 11 is received in the handle 13, the handle 13 secures the blade 11 in position with an engaging unit (not shown). When it is desired to rotate the blade 11 out of the handle 13, the user only has to push the pushing post 111 on the blade 11 and overcome the force applied by the engaging unit, and the blade 11 will be disengaged from the engaging unit, allowing the force applied by the torsion spring 21 to the blade 11 to spin the blade 11 out of the handle 13 rapidly.

However, a folding knife with either the elastic plate 15 or the torsion spring 21 is still inconvenient to use, and the major cause of inconvenience lies in the pushing post 111. First, to ensure portability of the folding knife 1, the pushing post 111 must not be too long, and yet the shortness of the pushing post 111 often hinders force application. Second, the pushing post 111 is designed to be pushed by the user's thumb and therefore must be adjacent to the pivot shaft, but when the blade 11 is secured by the engaging unit or the elastic plate 15 of the handle 13, it is difficult for the user to apply to the pushing post 111 a force large enough to overcome the securing force of the engaging unit or the elastic plate 15. Both factors compromise the convenience of the folding knife 1 considerably.

Besides, due to the shortness of the pushing post 111, the user's thumb will be close to a lateral side of the blade 11 when pushing the pushing post 111, and will be close to the rotating path of the blade 11 when the blade 11 spins rapidly out of the handle 13. If the user is unfamiliar with the operation method, holds the folding knife 1 improperly, or places his or her thumb/fingers at the wrong places, injury by the blade 11 may result.

As stated above, the conventional folding knives lack a convenient and safe mechanism for driving the blade 11 out of the handle 13, and in light of this, the issue to be addressed by the present invention is to overcome the drawbacks of the conventional folding knives and to develop a novel folding knife structure that allows more intuitive and safer operation.

### BRIEF SUMMARY OF THE INVENTION

In view of the fact that the blade of a conventional folding knife can only be driven via the pushing post on the blade, and that this driving mechanism leads to not only difficulty in force application but also safety issues, the inventor of the present invention put years of practical experience in research and development of knives into repeated trials and experiments and finally succeeded in developing a safe and easy-to-use folding knife with an assisted opening function as disclosed herein.

It is an objective of the present invention to provide a folding knife having an assisted opening function, wherein the folding knife includes a handle, a blade, a pushing member, and a first elastic member. The blade has one side formed with a cutting edge and the opposite side defined as the back of the blade. In addition, one end of the blade is formed as a tip, and a portion of the blade that is adjacent to the opposite end of the blade is pivotally connected via a pivot shaft to a portion of the handle that is adjacent to one end of the handle. The blade, therefore, can rotate with respect to the handle so that the cutting edge can be exposed outside the handle or received in one side (hereinafter referred to as the first side) of the handle. Moreover, a portion of the blade that is adjacent to both the pivot shaft and the cutting edge is provided with a notch. The pushing member has one end formed with a pushing portion and the opposite end pivotally connected in the handle at a position between the pivot shaft and the opposite end (hereinafter the second end) of the handle, wherein the pushing portion is exposed outside the opposite side (hereinafter the second side) of the handle. A portion of the pushing member that is adjacent to a middle section of the pushing member is formed with a pressing post. The pressing post is engaged in the notch while the cutting edge is received in the first side of the handle. When the pushing portion is pushed toward the second end of the handle, however, the pressing post pushes a wall portion of the notch that is relatively far from the pivot shaft, thereby rotating the blade away from the first side of the handle through a predetermined angle. The first elastic member has one end pressed against the portion of the pushing member that is adjacent to the middle section of the pushing member. The opposite end of the first elastic member is fixed in the handle at a position between the pushing member and the second end of the handle. Thus, the first elastic member applies a first elastic force to the portion of the pushing member that is adjacent to the middle section of the pushing member, pressing the pushing portion against the second side of the handle. When the blade is received in the handle, the user only has to push the pushing portion, or more particularly to push the wall portion of the notch with the pressing post, and the blade will be rotated out of the handle by the predetermined angle, allowing the cutting edge to be rotated completely out of the handle with ease.

### BRIEF DESCRIPTION OF THE SEVERAL VIEWS OF THE DRAWINGS

To facilitate comprehension of the objective, technical features, and effects of the present invention, some illustrative embodiments are detailed below with reference to the accompanying drawings, in which:

FIG. 1A and FIG. 1B schematically show a conventional folding knife;

FIG. 2 schematically shows another conventional folding knife;

FIG. 3 is an exploded perspective view of the folding knife in the first preferred embodiment of the present invention;

FIG. 4A and FIG. 4B schematically show operation of the folding knife in FIG. 3; and

FIG. 5A, FIG. 5B, and FIG. 6 schematically show three embodiments of the blade in the present invention.

### DETAILED DESCRIPTION OF THE INVENTION

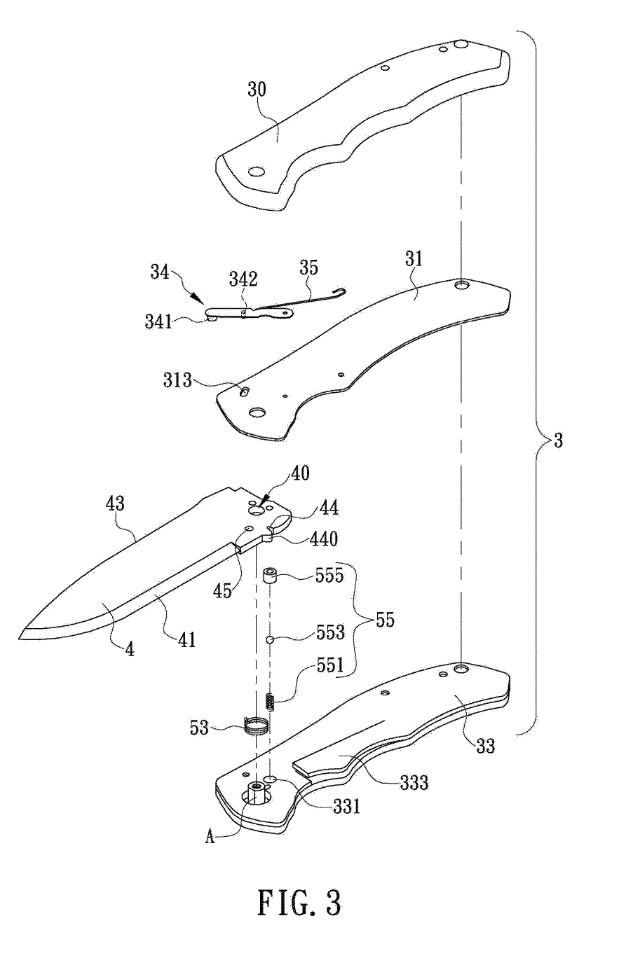

The present invention is a folding knife with an assisted opening function. Referring to FIG. 3, the folding knife in the first preferred embodiment of the invention includes a handle 3, a blade 4, a pushing member 34, and a first elastic member 35. The handle 3 is assembled from a plurality of plates such that a receiving space corresponding in configuration to the cutting edge 41 of the blade 4 is formed in one side (hereinafter referred to as the first side) of the handle 3. The cutting edge 41 is formed at one side of the blade 4 while the opposite side of the blade 4 is defined as the back of the blade 4. In addition, a tip is formed at one end of the blade 4, and a portion of the blade 4 that is adjacent to the opposite end (hereinafter the second end) of the blade 4 is provided with a pivot hole 40. A pivot shaft A passes through the pivot hole 40 to pivotally connect the blade 4 to a portion of the handle 3 that is adjacent to one end of the handle 3, in order for the blade 4 to rotate with respect to the handle 3 and consequently for the cutting edge 41 to be exposed outside the handle 3 or received in the receiving space in the first side of the handle 3.

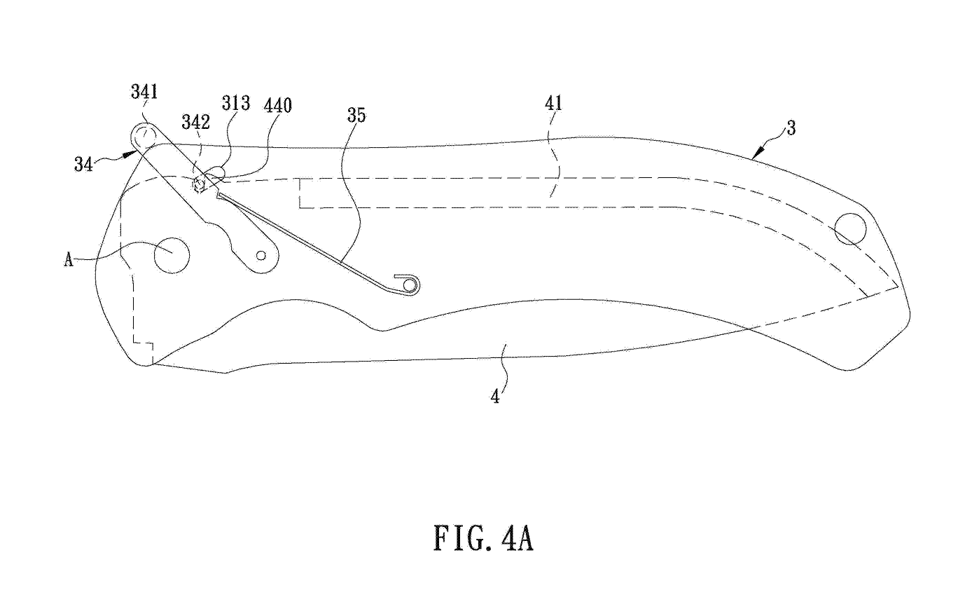

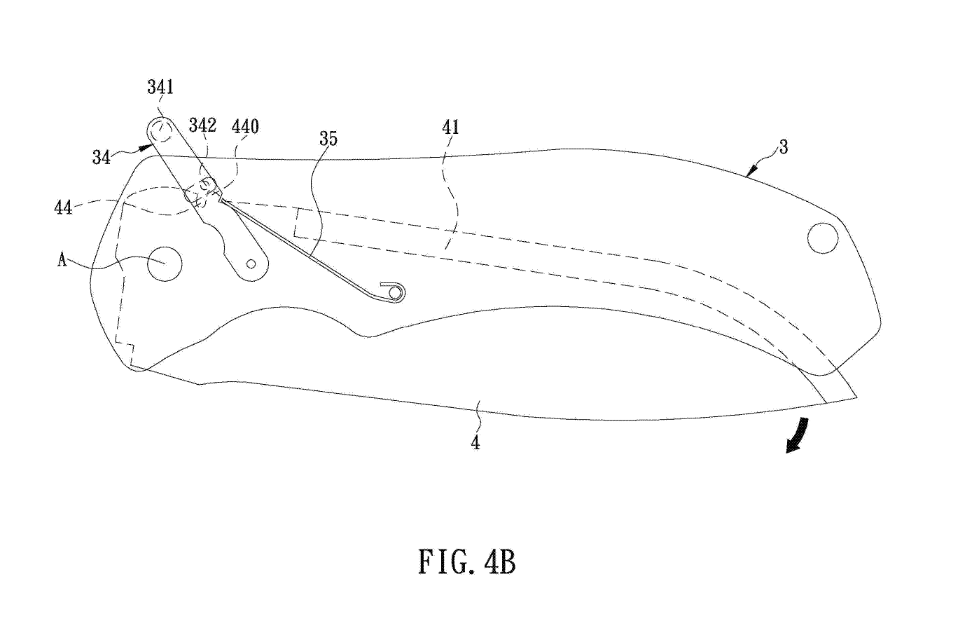

As shown in FIG. 3, FIG. 4A, and FIG. 4B, a portion of the blade 4 that is adjacent to the pivot shaft A and the cutting edge 41 is concavely provided with a notch 44, and a nearby portion of the blade 4 is protrudingly provided with a projection 440, which faces the same direction as the cutting edge 41. The projection 440 lies between the notch 44 and the cutting edge 41 and is joined to a wall portion of the notch 44 that is relatively far from the pivot shaft A. The pushing member 34 is a plate movably engaged in the handle 3 and has one end formed with a pushing portion 341. The pushing portion 341 is exposed outside the opposite side (hereinafter the second side) of the handle 3. The opposite end (hereinafter the second end) of the pushing member 34 is pivotally connected in the handle 3 at a position between the pivot shaft A and the opposite end (hereinafter the second end) of the handle 3. A portion of the pushing member 34 that is adjacent to a middle section of the pushing member 34 is formed with a pressing post 342. The pressing post 342 is engaged in the notch 44 and pressed against a wall portion of the notch 44 while the cutting edge 41 is received in the first side of the handle 3. The pressing post 342 pushes either the wall portion of the notch 44 that is relatively far from the pivot shaft A (i.e., the right wall portion of the notch 44 in FIG. 4B) or the projection 440 when the pushing portion 341 is pushed toward the second end of the handle 3, and in doing so, the pressing post 342 rotates the blade 4 away from the first side of the handle 3 through a predetermined angle (e.g., 4-8 degrees).

The first elastic member 35 (e.g., a linear spring or elastic plate) has one end (i.e., a free end) pressed against the portion of the pushing member 34 that is adjacent to the middle section of the pushing member 34. The opposite end (hereinafter the second end) of the first elastic member 35 is fixed in the handle 3 at a position between the pushing member 34 and the second end of the handle 3. Thus, when no pushing force is applied by the user to the pushing member 34, the first elastic member 35 applies a first elastic force to the portion of the pushing member 34 that is adjacent to the middle section of the pushing member 34, thereby pressing the pushing portion 341 against the second side of the handle 3.

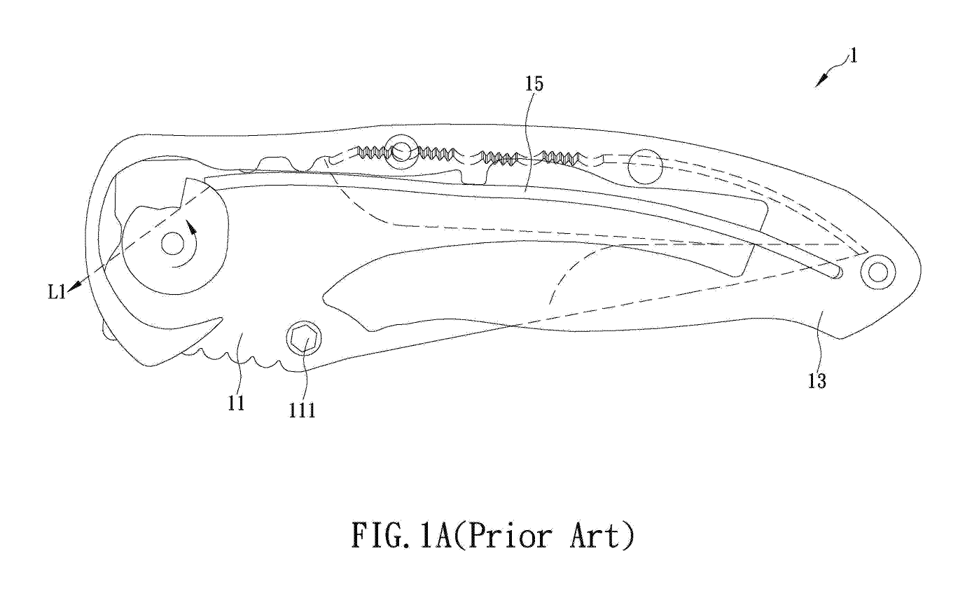

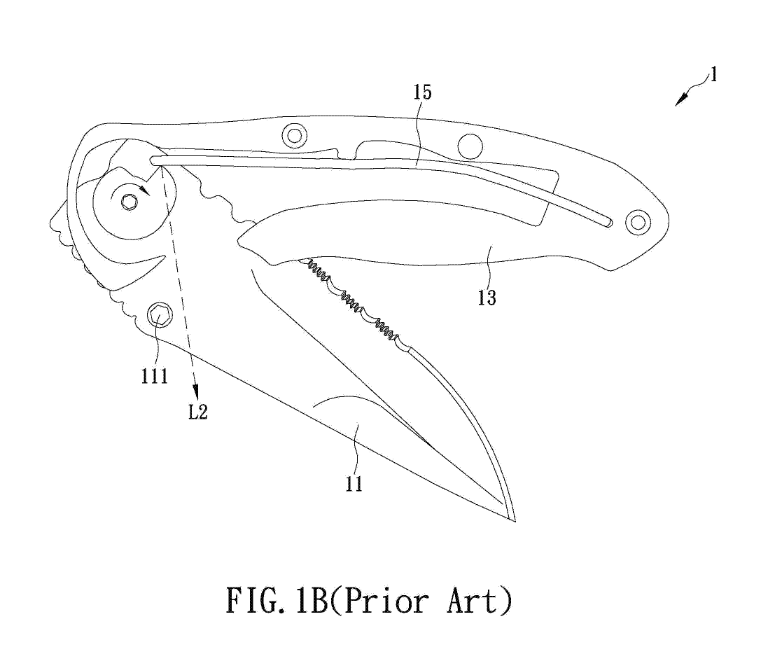

When the cutting edge 41 is received in the first side of the handle 3 and the pressing post 342 is engaged in the notch 44, the user only has to push the pushing portion 341 toward the second end of the handle 3 (i.e., toward the right side of FIG. 4A), and the pressing post 342 will push the wall portion of the notch 44 that is relatively far from the pivot shaft A. The pressing post 342 pushes the projection 440 along the wall portion of the notch 44 and eventually moves beyond the projection 440 such that the blade 4 is rotated out of the handle 3 by the predetermined angle to facilitate rotation of the entire cutting edge 41 out of the handle 3. In consequence, the difficulty of force application to the pushing post 111 as seen in the prior art (e.g., FIG. 1A) is resolved.

Referring back to FIG. 3, the handle 3 in this embodiment is composed of a first outer plate 30, a second outer plate 33, and a middle plate 31. Both the first outer plate 30 and the second outer plate 33 are pivotally connected via the pivot shaft A to the portion of the blade 4 that is adjacent to the second end of the blade 4. The second outer plate 33 is spaced from the first outer plate 30 by a predetermined distance to form the receiving space. The middle plate 31 is also pivotally connected to the portion of the blade 4 that is adjacent to the second end of the blade 4 via the pivot shaft A, and the middle plate 31 is positioned in the receiving space. The second end of the pushing member 34 is pivotally connected to the middle plate 31 while the second end of the first elastic member 35 is fixed on the middle plate 31.

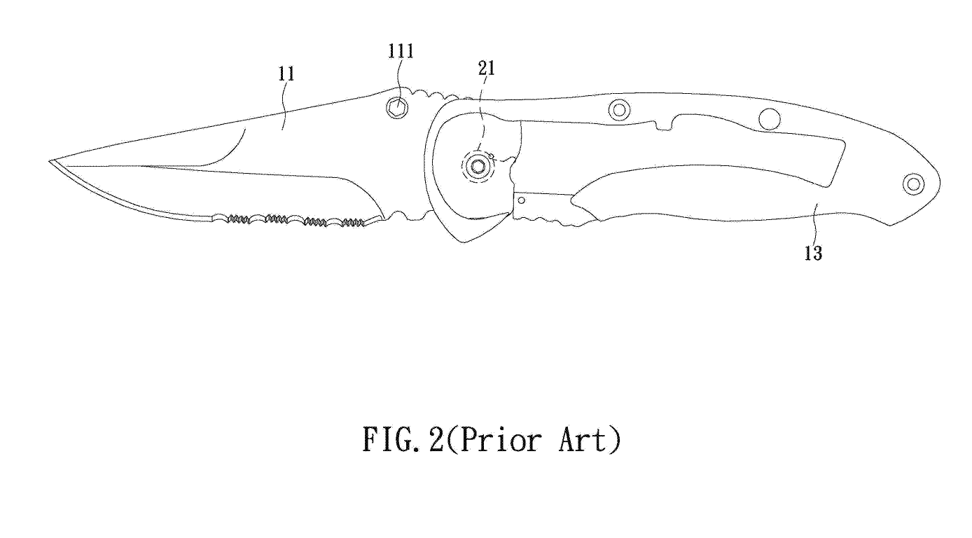

The blade 4 of the folding knife can be driven out of the handle 3 by various mechanisms, including, among others, the elastic plate 15 or the torsion spring 21 described above with reference to FIG. 1A to FIG. 2. In this embodiment, a torsion spring is used by way of example. Referring to FIG. 3, the folding knife further includes a second elastic member 53, which is a torsion spring mounted between the pivot shaft A and the blade 4. The second elastic member 53 has one end connected to the blade 4 and the opposite end connected to a portion of the handle 3 that is adjacent to the pivot hole 40. The second elastic member 53 applies a second elastic force to the blade 4 that tends to spin the blade 4 out of the handle 3.

To ensure that the blade 4 will not be driven out of the handle 3 by the second elastic member 53 while the cutting edge 41 is received in the handle 3, the folding knife can be further provided with an engaging unit 55. As shown in FIG. 3, the portion of the blade 4 that is adjacent to the second end of the blade 4 is provided with an engaging hole 45 while the engaging unit 55 is provided in the handle 3 and includes a sleeve 555, a compression spring 551, and an engaging member 553. The sleeve 555 is located in a recess 331 in the handle 3. The compression spring 551 is located in the sleeve 555 and has a bottom end pressed against the bottom surface of the recess 331. The engaging member 553 is also located in the sleeve 555 and has a bottom portion pushed by a top end of the compression spring 551 and a top portion able to extend beyond a top surface of the sleeve 555.

While the blade 4 is received in the first side of the handle 3, the engaging hole 45 corresponds in position to the engaging unit 55 such that the top portion of the engaging member 553 is exposed through the sleeve 555 and pressed against the wall of the engaging hole 45. At this point, the force applied by the compression spring 551 to the engaging member 553 is greater than the second elastic force applied by the second elastic member 53 to the blade 4 to rotate the blade 4 out of the handle 3, so the blade 4 will not be rotated by the second elastic force of the second elastic member 53. The user, on the other hand, can overcome the force applied by the compression spring 551 to the engaging member 553 by pushing the pushing member 34 such that the blade 4 is first rotated through the predetermined angle and then immediately driven by the second elastic force to spin the entire cutting edge 41 out of the handle 3.

The second outer plate 33 is further provided with a stop plate 333. The stop plate 333 has a free end extending to the vicinity of the pivot shaft A and into the receiving space in the handle 3. When the blade 4 has been rotated into the handle 3 and is received therein, the stop plate 333 is movably pressed against the blade 4. Once the blade 4 has sprung completely out of the handle 3, the stop plate 333 is pressed precisely against the second end of the blade 4 to secure the blade 4 in position.

It should be pointed out that, in this embodiment, the middle plate 31 is formed with a guide groove 313 corresponding in position to the pressing post 342. The pressing post 342 extends through the guide groove 313 in order to be positioned adjacent to the second end of the blade 4. The guide groove 313 ensures the precision of displacement of the pressing post 342. While the cutting edge 41 is received in the first side of the handle 3, the pressing post 342 is located at one end of the guide groove 313 and engaged in the notch 44. When the pushing portion 341 is pushed toward the second end of the handle 3, the pressing post 342 is displaced toward the opposite end of the guide groove 313 and pushes the wall portion of the notch 44 that is relatively far from the pivot shaft A, thereby rotating the blade 4 away from the first side of the handle 3.

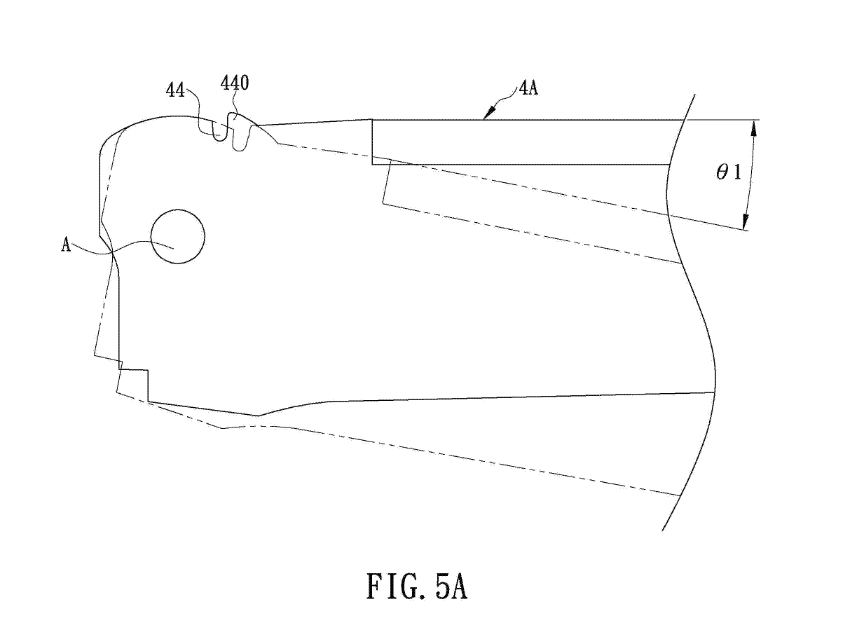

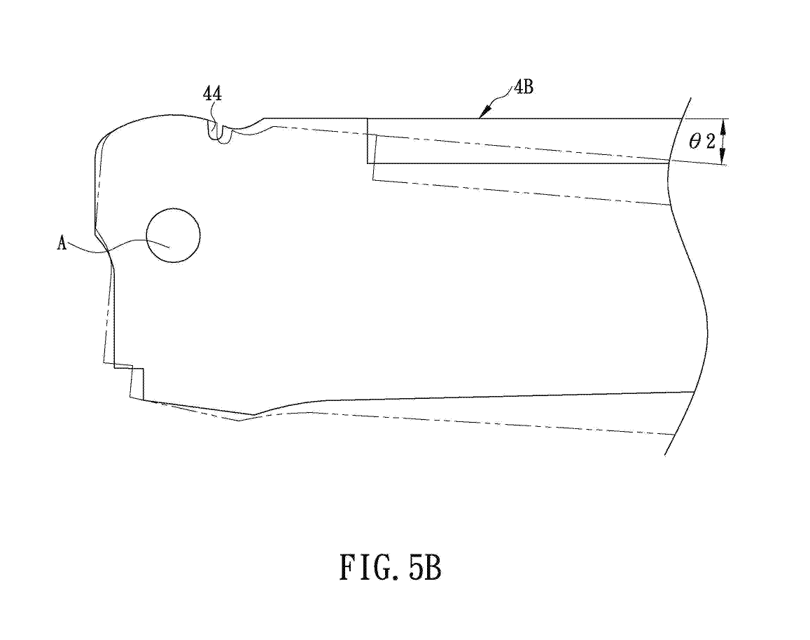

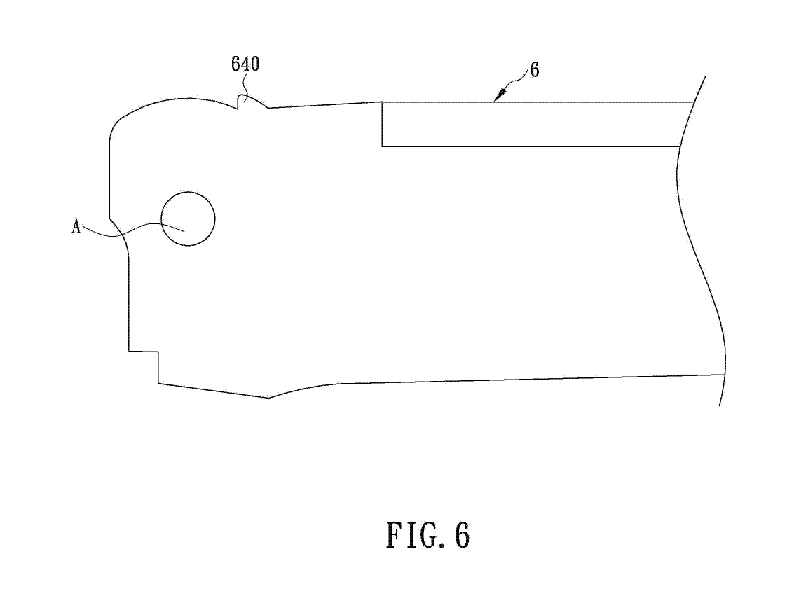

In this embodiment, the pressing post 342 rotates the blade 4 by first pushing the wall portion of the notch 44 that is relatively far from the pivot shaft A and then pushing the projection 440. In practice, however, the pressing post 342 may work in a different way. For example, the pressing post 342 may push only the wall portion of the notch 44 that is relatively far from the pivot shaft A, in order to rotate the blade 4 through the predetermined angle. Please refer now to FIG. 5A, which shows a blade 4A with the projection 440, and FIG. 5B, which shows a blade 4B with the notch 44 but without the projection 440. A comparison between the two drawings reveals that the blade 4A with the projection 440 (see FIG. 5A) features a greater distance for which the pressing post 342 (see FIG. 3) can be pressed along the blade 4A, and that therefore the pressing post 342 can rotate the blade 4A through a greater predetermined angle θ1. On the other hand, the blade 4B, which lacks the projection 440, is driven by the pressing post 342 only before the pressing post 342 moves past the wall portion of the notch 44, so the pressing post 342 can only rotate the blade 4B through a smaller predetermined angle θ2.

According to the above, the provision of the projection 440 allows the pressing post 342 to push the blade 4A more sufficiently, and this ensures that the predetermined angle through which the blade 4A is rotated by the user pushing the pushing member 34 and which activates further rotation of the blade 4A is more pronounced. However, a lack of the projection 440, as in the case with the blade 4B, has no adverse effect on achieving the objective of the present invention. That is to say, by pushing the pushing member 34, the user can still easily rotate the blade 4B at least through a predetermined angle in order to bring the blade 4B to a fully opened position.

Likewise, it is feasible for the pressing post 342 to push only the projection 440, as shown in FIG. 6, in which the blade 6 has a projection 640 but lacks the notch 44. When the blade 6 is used in conjunction with the handle 3, the pushing member 34, and the first elastic member 35 in FIG. 3 and is received in the first side of the handle 3, the pressing post 342 is pressed directly against a wall portion of the projection 640 that is adjacent to the pivot shaft A (i.e., the left wall portion of the projection 640 in FIG. 6). When the pushing portion 341 is subsequently pushed toward the second end of the handle 3, the pressing post 342 pushes the wall portion of the projection 640 that is adjacent to the pivot shaft A and thereby rotates the blade 6 away from the first side of the handle 3 through a predetermined angle.

While the invention herein disclosed has been described by means of specific embodiments, numerous modifications and variations could be made thereto by those skilled in the art without departing from the scope of the invention set forth in the claims.

What is claimed is:

1. A folding knife with an assisted opening function, comprising:
a handle having a first end, an opposite second end, a first side, and an opposite second side;
a blade having a side formed with a cutting edge, an opposite side defined as a back of the blade, a first end formed as a point, and an opposite second end, wherein a portion of the blade that is adjacent to the second end of the blade is pivotally connected by a pivot shaft to a portion of the handle that is adjacent to the first end of the handle, in order for the blade to rotate with respect to the handle, allowing the cutting edge to be exposed outside the handle or received in the first side of the handle, and a portion of the blade that is adjacent to the pivot shaft and the cutting edge is provided with a notch;
a pushing member having a first end formed with a pushing portion, an opposite second end pivotally connected in the handle at a position between the pivot shaft and the second end of the handle, and a middle section between the first and the second ends of the pushing member, wherein the pushing portion is exposed outside the second side of the handle, a portion of the pushing member that is adjacent to the middle section of the pushing member is formed with a pressing post, and the pressing post is configured to be engaged in the notch when the cutting edge is received in the first side of the handle and to push a wall portion of the notch that is relatively far from the pivot shaft and thereby rotate the blade away from the first side of the handle through a predetermined angle when the pushing portion is pushed toward the second end of the handle; and
a first elastic member having an end pressed against the portion of the pushing member that is adjacent to the middle section of the pushing member and an opposite end fixed in the handle at a position between the pushing member and the second end of the handle such that the first elastic member applies a first elastic force to the portion of the pushing member that is adjacent to the middle section of the pushing member and thereby presses the pushing portion against the second side of the handle.

2. The folding knife of claim 1, further comprising:
a second elastic member mounted between the pivot shaft and the blade, the second elastic member being a torsion spring and applying a second elastic force to the blade to rotate the blade out of the handle.

3. The folding knife of claim 2, wherein a portion of the blade that is adjacent to the second end of the blade is provided with an engaging hole, and the handle is provided with an engaging unit comprising:
a sleeve located in a recess of the handle and having a top surface;
a compression spring located in the sleeve and having a bottom end and a top end, wherein the bottom end of the compression spring is pressed against a bottom surface of the recess; and
an engaging member located in the sleeve and having a bottom portion and a top portion, wherein the bottom portion of the engaging member is pushed by the top end of the compression spring; the top portion of the engaging member is able to extend beyond the top surface of the sleeve; and when the cutting edge is received in the first side of the handle, the engaging hole corresponds to the engaging unit such that, with the compression spring applying a force to the engaging member, the top portion of the engaging member is pressed against a wall of the engaging hole, the force applied by the compression spring to the engaging member being greater than the second elastic force applied by the second elastic member to the blade to rotate the blade out of the handle.

4. The folding knife of claim 3, wherein the handle comprises:
a first outer plate pivotally connected by the pivot shaft to the portion of the blade that is adjacent to the second end of the blade;
a second outer plate pivotally connected by the pivot shaft to the portion of the blade that is adjacent to the second end of the blade, the second outer plate being spaced from the first outer plate by a predetermined distance such that a receiving space is formed, the receiving space corresponding in configuration to the cutting edge; and
a middle plate pivotally connected by the pivot shaft to the portion of the blade that is adjacent to the second end of the blade, the middle plate being positioned in the receiving space, with the second end of the pushing member pivotally connected to the middle plate.

5. The folding knife of claim 4, wherein the middle plate is formed with a guide groove corresponding in position to the pressing post; the pressing post extends through the guide groove in order to be positioned adjacent to the blade; when the cutting edge is received in the first side of the handle, the pressing post is located at an end of the guide groove and is engaged in the notch; and when the pushing portion is pushed toward the second end of the handle, the pressing post is displaced toward an opposite end of the guide groove and pushes the wall portion of the notch that is relatively far from the pivot shaft, thereby rotating the blade away from the first side of the handle.

6. The folding knife of claim 1, wherein a portion of the blade that is adjacent to the pivot shaft is protrudingly provided with a projection facing a same direction as the cutting edge, and the projection is joined to the wall portion of the notch that is relatively far from the pivot shaft.

7. The folding knife of claim 2, wherein a portion of the blade that is adjacent to the pivot shaft is protrudingly provided with a projection facing a same direction as the cutting edge, and the projection is joined to the wall portion of the notch that is relatively far from the pivot shaft.

8. The folding knife of claim 3, wherein a portion of the blade that is adjacent to the pivot shaft is protrudingly provided with a projection facing a same direction as the cutting edge, and the projection is joined to the wall portion of the notch that is relatively far from the pivot shaft.

9. The folding knife of claim 4, wherein a portion of the blade that is adjacent to the pivot shaft is protrudingly provided with a projection facing a same direction as the cutting edge, and the projection is joined to the wall portion of the notch that is relatively far from the pivot shaft.

10. The folding knife of claim 5, wherein a portion of the blade that is adjacent to the pivot shaft is protrudingly provided with a projection facing a same direction as the cutting edge, and the projection is joined to the wall portion of the notch that is relatively far from the pivot shaft.

11. A folding knife with an assisted opening function, comprising:
a handle having a first end, an opposite second end, a first side, and an opposite second side;
a blade having a side formed with a cutting edge, an opposite side defined as a back of the blade, a first end formed as a point, and an opposite second end, wherein a portion of the blade that is adjacent to the second end of the blade is pivotally connected by a pivot shaft to a portion of the handle that is adjacent to the first end of the handle, in order for the blade to rotate with respect to the handle, allowing the cutting edge to be exposed outside the handle or received in the first side of the handle, and a portion of the blade that is adjacent to the pivot shaft is protrudingly provided with a projection facing a same direction as the cutting edge;
a pushing member having a first end formed with a pushing portion, an opposite second end pivotally connected in the handle at a position between the pivot shaft and the second end of the handle, and a middle section between the first and the second ends of the pushing member, wherein the pushing portion is exposed outside the second side of the handle, a portion of the pushing member that is adjacent to the middle section of the pushing member is formed with a pressing post, and the pressing post is configured to be pressed against a wall portion of the projection that is adjacent to the pivot shaft, when the cutting edge is received in the first side of the handle, and to push the wall portion of the projection that is adjacent to the pivot shaft and thereby rotate the blade away from the first side of the handle through a predetermined angle when the pushing portion is pushed toward the second end of the handle; and
a first elastic member having an end pressed against the portion of the pushing member that is adjacent to the middle section of the pushing member and an opposite end fixed in the handle at a position between the pushing member and the second end of the handle such that the first elastic member applies a first elastic force to the portion of the pushing member that is adjacent to the middle section of the pushing member and thereby presses the pushing portion against the second side of the handle.

12. The folding knife of claim 11, further comprising:
a second elastic member mounted between the pivot shaft and the blade, the second elastic member being a torsion spring and applying a second elastic force to the blade to rotate the blade out of the handle.

13. The folding knife of claim 12, wherein a portion of the blade that is adjacent to the second end of the blade is provided with an engaging hole, and the handle is provided with an engaging unit comprising:
a sleeve located in a recess of the handle and having a top surface;
a compression spring located in the sleeve and having a bottom end and a top end, wherein the bottom end of the compression spring is pressed against a bottom surface of the recess; and
an engaging member located in the sleeve and having a bottom portion and a top portion, wherein the bottom portion of the engaging member is pushed by the top end of the compression spring; the top portion of the engaging member is able to extend beyond the top surface of the sleeve; and when the cutting edge is received in the first side of the handle, the engaging hole corresponds to the engaging unit such that, with the compression spring applying a force to the engaging member, the top portion of the engaging member is pressed against a wall of the engaging hole, the force applied by the compression spring to the engaging member being greater than the second elastic force applied by the second elastic member to the blade to rotate the blade out of the handle.

14. The folding knife of claim 13, wherein the handle comprises:
a first outer plate pivotally connected by the pivot shaft to the portion of the blade that is adjacent to the second end of the blade;
a second outer plate pivotally connected by the pivot shaft to the portion of the blade that is adjacent to the second end of the blade, the second outer plate being spaced from the first outer plate by a predetermined distance such that a receiving space is formed, the receiving space corresponding in configuration to the cutting edge; and
a middle plate pivotally connected by the pivot shaft to the portion of the blade that is adjacent to the second end of the blade, the middle plate being positioned in the receiving space, with the second end of the pushing member pivotally connected to the middle plate.

15. The folding knife of claim 14, wherein the middle plate is formed with a guide groove corresponding in position to the pressing post; the pressing post extends through the guide groove in order to be positioned adjacent to the blade; when the cutting edge is received in the first side of the handle, the pressing post is located at an end of the guide groove and is pressed against the wall portion of the projection that is adjacent to the pivot shaft; and when the pushing portion is pushed toward the second end of the handle, the pressing post is displaced toward an opposite end of the guide groove and pushes the wall portion of the projection that is adjacent to the pivot shaft, thereby rotating the blade away from the first side of the handle.
